(19) United States
(12) Patent Application Publication
(10) Pub. No.: US 2008/0175224 A1
(43) Pub. Date: Jul. 24, 2008

(54) System and Method for Configuring Voice Over IP Devices

(76) Inventor: Carlton Andrews, Austin, TX (US)

Correspondence Address: HAMILTON & TERRILE, LLP, P.O. BOX 203518, AUSTIN, TX, 78720, US

(21) Appl. No.: 11/624,261

(22) Filed: Jan. 18, 2007

(51) Int. Cl. H04L 12/66

(52) U.S. Cl. 370/352

(57) ABSTRACT

VoIP devices, such as VoIP telephones or analog telephone adapters, are configured through remote interaction with a configuration server. Configuration information for a VoIP device generated by input to an order engine is stored at a TFTP configuration server by association with a MAC address of the VoIP device. For example, the MAC address is scanned with an optical scanner from a tag on the VoIP device and used as the name for storing the associated configuration information. At power up, the VoIP device connects to the TFTP server, retrieves the configuration information by reference to the MAC address name and applies the configuration information to prepare for interaction with a VoIP service.

### BACKGROUND OF THE INVENTION

1. Field of the Invention

The present invention relates in general to the field of information handling system voice communications, and more particularly to a system and method for configuring voice over IP (VoIP) devices.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems have become more prevalent in homes and businesses, end users have sought to leverage information handling system capabilities to perform a variety of tasks. One example is the use of information handling systems to support Voice over Internet Protocol (VoIP) telephone communications. VoIP digitizes audible voice communications at a premise, places the digitized audible information into packets using the Internet Protocol and sends the packets through the Internet to another premise where the digitized audible information is decoded and presented as audible sounds. An advantage of VoIP is that it allows end users to leverage an Internet connection to obtain long distance voice communication. Telephone service is generally specialized. VoIP telephones are available that interface directly with a network to communicate through the Internet and include hardware and software components to code and decode voice information in VoIP packets. As an alternative, analog telephone adapters (ATAs) are available that support an interface with both an analog telephone and a network. Hardware and software within the ATA converts analog telephone signals to VoIP for communication over the network and converts network VoIP packets to analog signals for presentation by an analog telephone.

One difficulty with using VoIP telephone communication is that each VoIP device must typically be configured with network information before supporting VoIP communication. Consumer VoIP devices, such as cable modems and ATAs, are preconfigured to log in to the remote server of the service provider so that an end user may activate the service by calling the service provider to give the MAC address of the VoIP device. The service provider uses the verbally-provided MAC address to link the VoIP device to a VoIP device calling in and an associated account, IP address and phone number. Enterprise VoIP device solutions generally employ a locally-networked server that supports multiple VoIP devices, such as VoIP telephones. VoIP telephones typically have a front panel or Web interface that allows an information technology administrator to program VoIP server connection information into the telephone. A VoIP telephone may also be programmed to connect to a TFTP server on boot and extract an XML based file that will contain the VoIP server connection information. The XML file is typically manually created or copied and altered from a template. Generally, setting up a VoIP device presents a challenge for technically challenged end users.

### SUMMARY OF THE INVENTION

Therefore a need has arisen for a system and method which simplifies the configuration of VoIP devices.

In accordance with the present invention, a system and method are provided which substantially reduce the disadvantages and problems associated with previous methods and systems for configuration of VoIP devices. Address information scanned from a VoIP device is stored on a configuration server along with configuration information under a name associated with the address information. The VoIP device self-configures by contacting the configuration server, looking up the configuration information by reference to the address information, and applying the configuration information to flash memory of the VoIP device.

More specifically, an order engine presents an order form to gather configuration information for a selected VoIP device, such as a VoIP telephone or an analog telephone adapter. The configuration information is stored at a configuration server and the order is forwarded to a manufacturer or reseller. A physical address reader, such as an optical scanner, reads a MAC address from a tag on the VoIP device, such as a bar code, and stores the configuration information associated with the VoIP device on the configuration server by reference to the MAC address. The VoIP device is powered and interfaced through a network to communicate with the configuration server and to retrieve the configuration information by reference to the MAC address. A configuration engine on the VoIP device applies the configuration information to prepare the VoIP device to interact with a VoIP service defined by the configuration information.

The present invention provides a number of important technical advantages. One example of an important technical advantage is that VoIP device configuration is automated through a user-friendly order form so that ordered VoIP devices are shipped ready to provide a dial tone “out of the box.” Automated configuration avoids errors that commonly arise with manual configuration performed through an interface panel of a VoIP device. Electronic scanning of MAC address information for association with order configuration information prevents errors related to manual reading and entry of MAC address information for establishing service at a VoIP provider. The end user has a positive “out of box” experience where the ordered VoIP device simply plugs in and works.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of examples of VoIP networks;

FIG. 2 depicts a block diagram of a system for automated configuration of VoIP devices; and

FIG. 3 depicts a flow diagram of a process for automated configuration of VoIP devices.

### DETAILED DESCRIPTION

Remote configuration of VoIP devices allows end users to set up VoIP service through an information handling system interface before delivery of the VoIP device. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

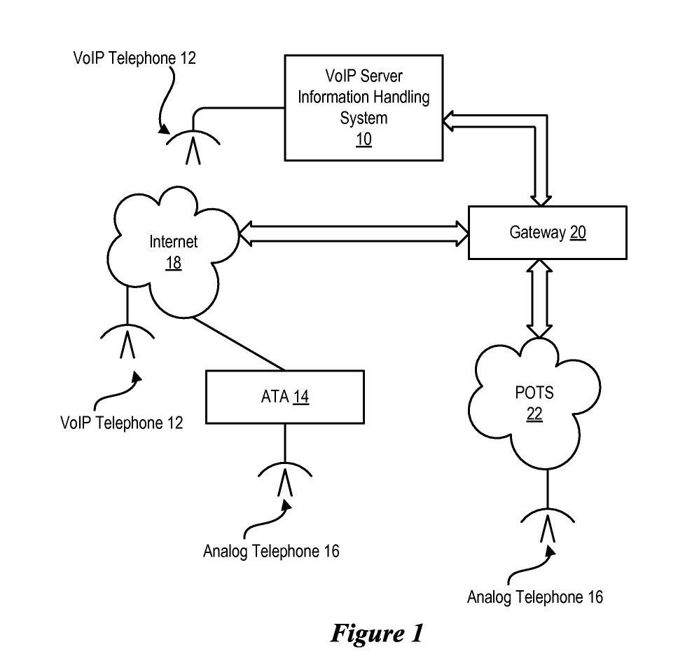

Referring now to FIG. 1, a block diagram depicts examples of Voice over Internet Protocol (VoIP) networks. A VoIP server information handling system 10 supports VoIP communication in which voice information is sent in packets using Internet Protocol (IP). Audible sounds captured at an end user location are converted to electrical signals and digitized into VoIP packets by VoIP devices, such as a VoIP telephone 12 or an analog telephone adapter 14 interfaced with an analog telephone 16. For example, an analog telephone 16 converts audible sounds to an analog electrical signal that is provided to analog telephone adapter 14. Analog telephone adapter 14 samples the analog signal to generate digital voice information and packetizes the voice information using the Internet Protocol to send the voice information through an IP based network, such as the Internet 18 or a local area network supported by a VoIP server 10. Voice information sent to analog telephone adapter 14 is decoded from digital to analog signals and provided to analog telephone 16 for presentation as audible information. A VoIP telephone 12 includes in a single housing both the analog components for capturing and presenting audible information and the digital components for communicating voice information through an IP network.

VoIP telephone 12 and analog telephone adapter 14 are essentially specialized information handling systems designed specifically to handle voice telephone communications and, sometime, video communications. VoIP telephones12 and analog telephone adapters 14 are configured to operate in a variety of network arrangements using a device specific MAC address and an assigned IP address much like information handling systems use to interact with the Internet. For example, an analog telephone adapter 14 interfaces with a home telephone analog line and an IP network line, such as an Internet connection provided by a cable modem, to provide voice communication through Internet 18. VoIP telephones 12 connect directly with Internet 18 or form a local voice network supported by a VoIP server 10, such as an enterprise telephone system. A gateway 20 converts voice information between an IP format used to communicate over Internet 18 and a TDM format used to communicate through the Plain Old Telephone System (POTS) 22. Gateway 20 allows communication of voice information between VoIP networks and analog-based telephone systems by tracking the locations of IP network addresses and analog telephone numbers.

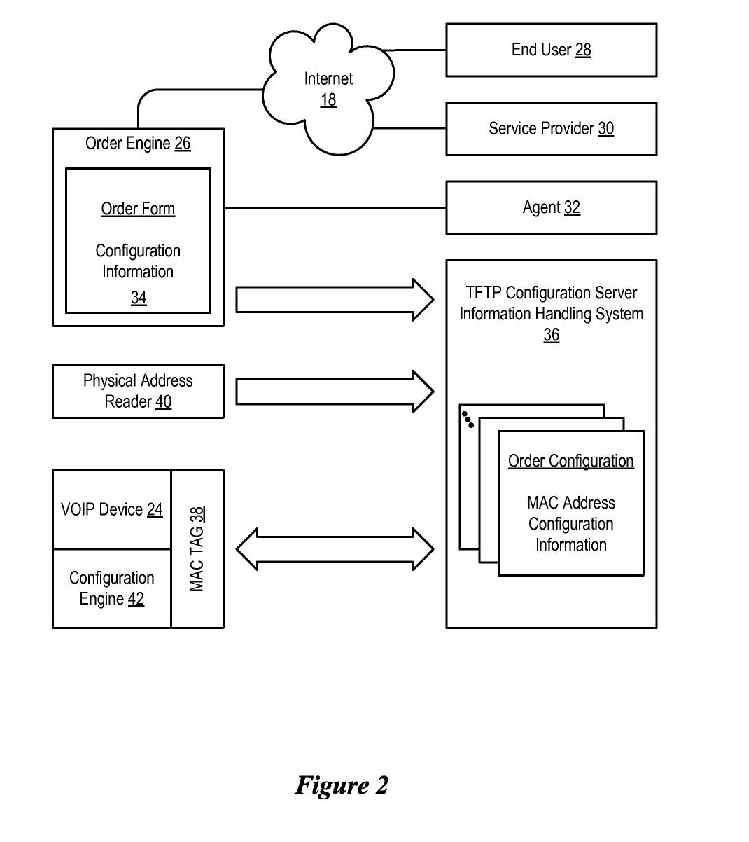

Referring now to FIG. 2, a block diagram depicts a system for automated configuration of VoIP devices 24, such as VoIP telephones or analog telephone adapters. An order engine 26 accepts orders for VoIP devices through Internet 18 from an end user 28, a VoIP service provider 30 or an agent 32. End user 28 is, for instance, an enterprise information technology professional seeking to purchase VoIP devices from a manufacturer or reseller for installment in an enterprise VoIP telephone system. Service provider 30 is, for instance, a cable Internet provider seeking to purchase VoIP devices from a manufacturer or reseller for installment in a home to provide VoIP service to the home. Agent 32 is, for instance, an agent of the manufacturer or reseller who places orders for customers based on information provided by customers, such as with a telephone conversation. Order engine 26 provides end user 28, service provider 30 and agent 32 with an order form 34 that accepts configuration information for configuring a VoIP device 24 selected for purchase. For example, order form 34 is an online Web page filled out with the type of VoIP device ordered, the VoIP service provider, and service provider login information, such as a login identification and password. Selection of a service provider automatically associates other relevant configuration information for establishing VoIP service, such as supported codecs, codec negotiation order, call forwarding parameters, multiparty access, international speed dialing, etc . . . . Alternatively, this or other configuration information may be manually selected through order form 34.

Once order form 34 is completed, order engine 26 forwards the order form configuration information to a TFTP configuration server information handling system 36. VoIP devices 24 selected to fill each order are prepared for shipment by scanning the MAC address from a MAC tag 38 coupled to a selected VoIP device 24 with a physical address reader 40, such as an optical scanner that scans a bar code representing the MAC address. Physical address reader 40 electrically communicates the scanned MAC address to TFTP configuration server 36 for association with the order. For example, a manufacturing floor technician is presented with an order form, selects a VoIP device identified by the order form and optically scans the VoIP device MAC address from the MAC tag 38 of the VoIP device 24. TFTP configuration server 36 associates the scanned MAC address with the order form to generate an order configuration having configuration information sufficient to establish VoIP service with the VoIP device 24 having the scanned MAC address. For example, the order configuration is stored as an XML file having a name that includes the MAC address of the associated VoIP device 24. Upon power up of VoIP device 24, a configuration engine 42 connects to the TFTP server to download the order configuration identified by the MAC address of the VoIP device 24 used in the name storing the order configuration on TFTP configuration server 36. For example, VoIP device 24 makes a DHCP request, locates the server through DNS or directly, downloads the order information and flashes the configuration information into flash memory to activate VoIP service. Configuration engine 42 applies the configuration information to establish VoIP service with the VoIP device 24 in accordance with the order placed through the order form. Configuration engine 42 is activated on the manufacturing floor prior to shipment of VoIP device 24 or, alternatively, may be activated by an end user after shipment through an Internet interface with TFTP configuration server 36.

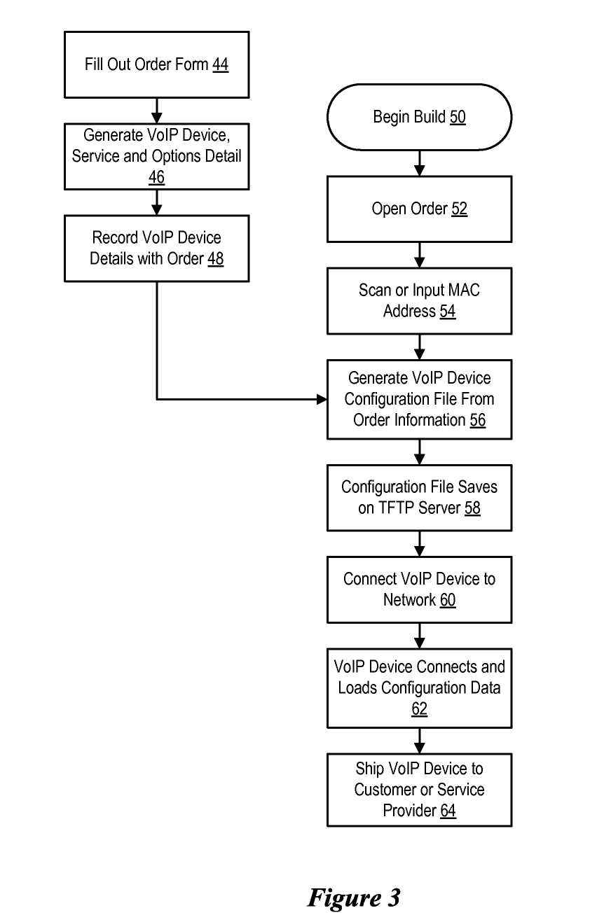

Referring now to FIG. 3, a flow diagram depicts a process for automated configuration of VoIP devices. The process begins at step 44 with placement of an order for a VoIP device by filling out an order form. At step 46, phone, service and optional details are generated for the order based on the information submitted to the order form, such as selection of a service provider or service. At step 48, the generated phone details are recorded with the order information and forwarded to a configuration server. At step 50, a build process begins to build a VoIP device, such as at a manufacturing or resale location. The order for a VoIP device is opened at step 52 and, at step 54 the MAC address associated with a selected VoIP device is scanned or otherwise input, such as with an optical scanner that reads a bar code affixed to the VoIP device. At step 56, a phone configuration file is generated from the order information and MAC address. At step 58, the configuration file is saved on a TFTP server, such as by a name that references the MAC address of the VoIP device. At step 60, the VoIP device is connected to a network that allows access to the TFTP device. At step 62, the VoIP device connects to the network, retrieves the configuration file from the TFTP server by reference to the MAC address and loads the configuration data from the configuration file. The configuration data is applied at the VoIP device to configure the VoIP device to support a VoIP service and, at step 64, the VoIP device is shipped to the customer or VoIP service provider to fulfill the order placed in the order form.

Although the present invention has been described in detail, it should be understood that various changes, substitutions and alterations can be made hereto without departing from the spirit and scope of the invention as defined by the appended claims.

What is claimed is:

1. A system for configuring VoIP devices, the system comprising:
an order engine operable to accept an order for one or more of the VoIP devices, the order associating configuration information with each of the VoIP devices;
an address reader operable to read an address associated with each of the VoIP devices;
a configuration server interfaced with the order engine and the address reader, the configuration server operable to store the configuration information in association with an address provided by the address reader; and
a configuration engine associated with the VoIP device and operable to interface with the configuration server at power up of the VoIP device to retrieve the configuration information associated with the address of the VoIP device.

2. The system of claim 1 wherein the VoIP device comprises a VoIP telephone.

3. The system of claim 1 wherein the VoIP device comprises an analog telephone adapter.

4. The system of claim 1 wherein the configuration information comprises login information sufficient to establish VoIP communication between the VoIP device and a VoIP service.

5. The system of claim 1 wherein the address reader reads a MAC address associated with the VoIP device.

6. The system of claim 5 wherein the configuration server stores the configuration for each VoIP device under a name associated with the MAC address read from the VoIP device.

7. The system of claim 6 wherein the address reader comprises an optical scanner operable to read the MAC address from a tag coupled to the VoIP device.

8. The system of claim 1 wherein the order engine comprises an order form operable to accept configuration information input through the Internet.

9. A method for configuring a VoIP device, the method comprising:
gathering configuration information sufficient for the VoIP device to establish VoIP communication through a network;
scanning address information from the VoIP device;
storing the configuration information on a configuration server with a name having the scanned address information;
interfacing the VoIP device with the configuration server;
automatically retrieving the configuration information from the configuration server with the VoIP device by reference to the name; and
applying the configuration information at the VoIP device to enable VoIP communication over the VoIP device.

10. The method of claim 9 wherein scanning address information from the VoIP device further comprises scanning the MAC address of the VoIP device.

11. The method of claim 10 wherein storing the configuration information further comprises storing the configuration information on a configuration server with a name having the MAC address.

12. The method of claim 10 wherein scanning further comprises scanning a tag attached to the VoIP device with an optical scanner, the tag having the MAC address.

13. The method of claim 9 wherein the VoIP device comprises a VoIP telephone.

14. The method of claim 9 wherein the VoIP device comprises an analog telephone adapter.

15. The method of claim 9 wherein the configuration information comprises login information sufficient to establish VoIP communication between the VoIP device and a VoIP service.

16. The method of claim 9 wherein automatically retrieving the configuration information comprises:
performing a boot of the VoIP device to contact a TFTP server; and
looking up the configuration information by reference to the MAC address of the VoIP device.

17. A method for establishing VoIP communication through a VoIP device, the method comprising:
associating login information for the VoIP device with that MAC address of the VoIP device;
storing the login information at a TFTP server by reference to the MAC address;
performing a boot of the VoIP device to contact the TFTP server;
retrieving the login information by reference to the MAC address; and
applying the login information to enable the VoIP device to interface with a VoIP service.

18. The method of claim 17 wherein the VoIP device comprises a VoIP telephone.

19. The method of claim 17 wherein the VoIP device comprises an analog telephone adapter.

20. The method of claim 17 further comprising:
scanning the MAC address of the VoIP device from a tag coupled to the VoIP device.
